(19) United States
(12) Patent Application Publication
(10) Pub. No.: US 2007/0004441 A1
(43) Pub. Date: Jan. 4, 2007

(54) Method for operating a mobile radio telephone system, mobile radio telephone system and base station

(76) Inventors: Volker Breuer, Botzow (DE); Frederic Charpentler, Berlin (DE)

Correspondence Address: Staas & Halsey, Suite 700, 1201 New York Avenue N W, Washington, DC, 20005, US

(21) Appl. No.: 10/557,612

(22) PCT Filed: May 5, 2004
(86) PCT No.: PCT/EP04/50717

§ 371 Date: Nov. 22, 2005

(30) Foreign Application Priority Data
May 22, 2003 (DE) 10323191.9

(51) Int. Cl. H04B 1/04; H04B 7/00; H01Q 11/12

(52) U.S. Cl. 455/522; 455/127.1

(57) ABSTRACT

A mobile radio telephone system has a power amplifier for amplifying signals to be transmitted to subscriber stations. A measure of the working load of the power amplifier is detected and transmitted to a central control unit of the mobile radio telephone system.

### CROSS REFERENCE TO RELATED APPLICATIONS

This application is based on and hereby claims priority to German Application No. 10323191.9 filed on May 22, 2003, the contents of which are hereby incorporated by reference.

### BACKGROUND OF THE INVENTION

1. Field of the Invention

The invention relates to a method for operating a mobile radio telephone system, a mobile radio telephone system and a base station for a mobile radio telephone system.

2. Description of the Related Art

Mobile radio telephone systems are radio communication systems, in which network-side stations maintain a radio connection with subscriber stations. Numerous cellular mobile radio telephone systems are known which comprise a plurality of radio cells supplied by at least one network-side radio station. Typical examples include systems operating according to the GSM, UMTS, IS-95, CDMA2000 standards, and many others. These systems generally provide each radio cell with a base station. The radio cells of a number of radio cells are connected to a central radio network controller (BSC or RNC).

The UMTS standard discloses how, in each radio cell, a ratio of the current output power of a power amplifier of the base station located in the radio cell to a maximum output power admissible for the radio cell is to be communicated to the higher-ranking radio network controller. This information is required in order to estimate the working load of the radio cells. The maximum capacity of a radio cell is limited by the radio resources available. The radio resources are essentially determined by the frequency bandwidths available and an admissible maximum total transmit power of the radio cell. To prevent interference having too much of an adverse effect on the adjacent radio cells, this type of maximum admissible transmit power is determined for each cell.

### SUMMARY OF THE INVENTION

An object underlying the invention is to specify a method for operating a mobile radio telephone system, which allows an improved utilization of the radio resources available in a radio cell.

A method according to the invention for operating a mobile radio telephone system provides a power amplifier for amplifying the signals to be transmitted to subscriber stations. A measure of the working load of the power amplifier is detected and transmitted to a central control unit of the mobile radio telephone system.

The power amplifier can be a component in a base station of the mobile radio telephone system for example. If a radio cell has a number of transmitter locations, then each of these locations has at least one power amplifier.

In contrast to the above-described related art, which makes provision for detecting the working load of the radio cell, the individual working load of a specific power amplifier is determined according to the invention and can be communicated to the central control unit, which can be a radio network controller for example. The maximum output power admissible for the power amplifier (with only one amplifier in a radio cell) will frequently deviate from the maximum admissible total transmit power of the corresponding radio cell in which the amplifier is located. The maximum admissible output power of each amplifier is generally determined such that the amplifier is prevented from overloading, or prevented from operating in a non-linear region of its performance characteristic, thereby resulting in distortions. In contrast, the maximum admissible transmit power of the cell is determined such that there is no major impact on the emissions from adjacent radio cells. The main consideration is thus to limit interference. The maximum admissible transmit power of the cell is therefore determined accordingly on the network side.

The invention can be used in any kind of mobile radio telephone system.

With the presence of a number of power amplifiers per radio cell, the invention particularly allows for the provision of not only a measure of the working load of the total radio cell but also a measure of the working load of each individual amplifier on the network side of the mobile radio telephone system. Provided the resource allocation in the central control unit is planed, it is then possible for example to implement the resource allocation such that the power amplifier is loaded as equally as possible.

A number of power amplifiers in a radio cell can be used in particular if a transmit diversity is provided within a radio cell, in which the signals of the same connection are simultaneously transmitted to the same subscriber station over at least two amplifiers and associated antennae. An unbalanced working load of the amplifier can thus cause the transmit diversity to only be used for one part of the connections, whilst the use of only one amplifier can be provided for other connections.

According to a development of the invention, the power amplifier is located in a radio cell of the mobile radio telephone system and the central control unit is located outside the radio cell. Thus, the measures transmitted to the central control unit can form the basis for an allocation of connections to the individual power amplifiers, which are either implemented by the central control unit or other network-side components. The central control unit can be a radio network controller.

With one development of the invention, the measure of the working load of the power amplifier advantageously depends on both the output power currently provided by the power amplifier and also on the maximum admissible output power of the power amplifier. These two values can typically be related to one another, such that the detected measure and the measure transmitted to the central control unit is correspondingly “standardized” and specifies a percentage level of the working load.

According to a development of the invention, a number of power amplifiers for amplifying the signals to be transmitted to the subscriber stations are provided and at least one measure of the working load of the power amplifier is detected.

According to one embodiment of the invention, a measure of the working load can be detected in this case for each of the power amplifiers. This enables very detailed information of the unit responsible for a resource assignment via the level of working load of each individual amplifier.

Alternatively it is also possible to detect which measure of the working load of the power amplifier has the greatest value, the measure with the greatest value being transmitted to the central control unit. This information notifies the central control unit about the most critical level of working load of one of the amplifiers (in terms of resources still to be made available).

It is advantageous if, in addition to the at least one measure of the working load of the power amplifier, a measure of the working load of the radio cell in which the power amplifier is located is also detected, and the measure of the working load of the radio cells is similarly transmitted to the central control unit. This is particularly favorable in the case of the exemplary embodiment described in the previous paragraph. It is then possible, with the aid of both measures, to determine on the network side whether only at least one of the amplifiers has reached a critical range of its working load or whether the radio cell is already approaching its capacity limit. The sum of the maximum output power admissible for each individual power amplifier, (with a number of amplifiers per radio cell), is frequently significantly greater than the maximum total transmit power of the corresponding radio cell in which the amplifier is found. This is due to the fact that the amplifier can be loaded differently throughout the operation. The maximum admissible output power of each amplifier is generally determined such that the amplifier is prevented from overloading. In contrast, the maximum admissible transmit power of the cell (also referred to subsequently as maximum admissible sum of the output power of the power amplifier of the corresponding cell) is determined such that there is no major impact on emissions from adjacent radio cells.

According to a preferred embodiment, the measure of the working load of the radio cells depends both on the sum of the output powers currently made available by all power amplifiers of the radio cells and also on a maximum admissible sum of the output powers of the power amplifier. The last-mentioned factor is the maximum admissible transmit power of the radio cells as mentioned in the last paragraph. With this embodiment, the standardization with the last-mentioned factor as a measure of the working load of the radio cells results in a percentage working load of the radio cell.

The measure of the working load of the radio cell can be transmitted simultaneously with the measure of the working load of the power amplifier or both can be transmitted to the central control unit at different points in time. For instance, the latter makes it possible to determine whether the measure of the working load of one of the power amplifiers or the measure of the working load of the radio cell has a greater value, with either the measure of the working load of this power amplifier or the measure of the working load of the radio cell being transmitted to the central control unit as a function of this result. This ensures that the central control unit is always informed about the most critical level of working load in each instance (that of one of the amplifiers or that of the radio cell overall). At the same time transmission resources to the central control unit are saved since both measures of the working load are not transmitted at the same time.

It is particularly advantageous if a decision is made on a distribution of signals to be transmitted to the power amplifier which takes account of the measures of the working load transmitted to the central control unit. This can be effected by the central control unit for instance. The presence of a number of power amplifiers allows the available power amplification resources to be used as equally as possible.

The measures according to the invention of the working load can be advantageously detected repeatedly and transmitted to the central control unit. The detection and transmission can be effected periodically or also on request by the central control unit.

The mobile radio telephone system according to the invention and the base station according to the invention include components required for the implementation of the method according to the invention and its embodiments and developments. Embodiments of the invention are also possible in which the method is not or is only partly performed by components of a base station.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a radio cell in a UMTS mobile radio telephone system.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

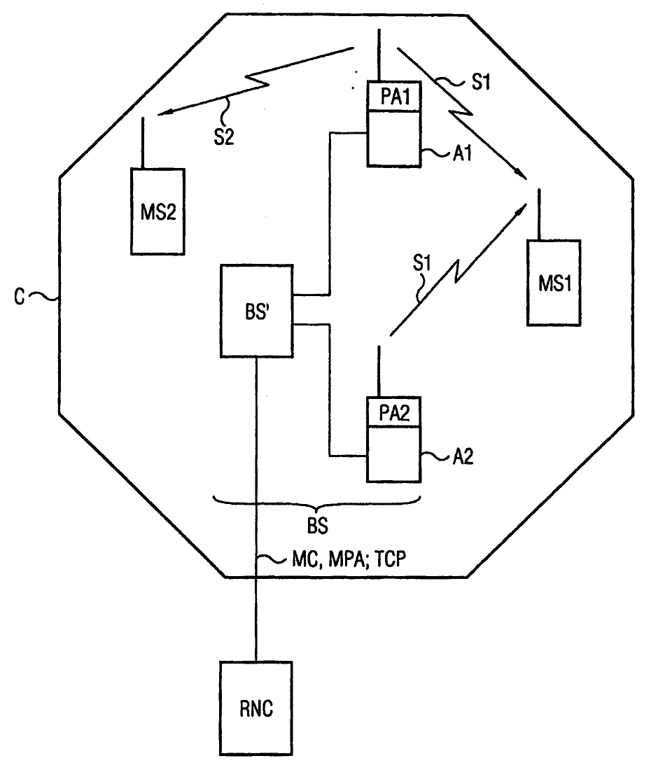

The invention is described in more detail below with reference to an exemplary embodiment illustrated in FIG. 1.

FIG. 1 shows a radio cell C of a UMTS mobile radio telephone system, which is supplied by a base station BS. The base station is formed by a local unit BS′ and by two remote antenna units A1, A2 connected thereto. The base station BS can maintain connections to the subscriber stations MS1, MS2, by which corresponding signals S1, S2 can be transmitted.

In this case, first signals S1 are transmitted to the first subscriber station MS1 by the first antenna unit A1 and simultaneously by the second antenna unit A2 following a transmit diversity method. Connections can however also only be maintained via one of the antenna units. For example second signals S2 are only transmitted via the first antenna unit A1 to the second subscriber station MS2.

Each antenna unit A1, A2 includes a power amplifier PA1, PA2, which serves to amplify the signals S1, S2 to be emitted over the respective antenna. Furthermore, the local unit BS′ of the base station BS is connected to a central control unit in the form of a radio network control RNC, which is connected to a number of similar base stations of other radio cells (not shown).

For each amplifier PA1, PA2 the base station BS detects the following measure Ms for its working load on the network controller RNC:
Mn=Pn/Pnmax, with n=1, 2,
With Pn being the current output and/or transmit power of the amplifier PAn and Pnmax being its maximum admissible output power.

Furthermore, the base station BS detects that measure of the two measures M1, M2, which has the greatest value:
MPA=max (M1; M2).

The base station transmits this greatest value MPA to the radio network controller. With other exemplary embodiments, both measures M1, M2 can naturally also be communicated to the radio network controller.

Furthermore, a measure of the working load of the radio cell C is detected in the base station BS and is similarly communicated to the radio network controller:
MC=(P1+P2)/PCmac,
with PCmax being the maximum transmit power admissible in the radio cell which was previously determined by the radio network controller RNC.

With this example, the radio network controller is able to detect whether the operation of the radio cell C is potentially threatened if the maximum admissible power of the cell (PCmax) or the maximum admissible power of one of the amplifiers (Pnmax) is exceeded.

With this exemplary embodiment, the measures of the working load Mn, MC are periodically detected and transmitted to the controller RNC. The radio network controller RNC is thus able to distribute the radio resources of the radio cell C as optimally as possible, so that it is possible to avoid exceeding both the maximum admissible output power Pnmax per power amplifier Pan and also the maximum admissible transmit power PCma of the radio cell C. The resource distribution can thus cause a specific number of connections with the corresponding signals S1, S2 to be transmitted to be assigned to the power amplifiers. If an excessively high working load of the first power amplifier PA1 emerges for instance, the controller RNC can determine that the signals S1 of the connection to the first subscriber station MS1 are no longer transmitted in diversity mode, but instead exclusively via the second amplifier PA2. This relieves the load on the first amplifier PA1.

In another exemplary embodiment of the invention, the two measures MPA, MC are not simultaneously transmitted to the radio network controller. Instead, according to the following formula, a further parameter is calculated from these measures and is transmitted to the radio network controller:
TCP=max (MC; MA).

This means that only the greater of the two values is transmitted to the controller RNC in each instance. This allows the required transmission capacity and/or the signaling effort to be reduced between the base station BS and the controller RNC.

It is also possible to arrange the amplifiers PA1, PA2 in the local unit BS′ of the base station BS, in other words separate from the antenna. This is known as a passive antenna as opposed to an active antenna, in which the amplifiers (as in FIG. 1) are arranged directly on the antennas.

With other exemplary embodiments of the invention, more than two antennas can also be provided in each instance with a power amplifier within the base station BS.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method for operating a mobile radio system in which the signals to be transmitted to subscriber stations are amplified in a power amplifier, comprising:
detecting a measure of the working load of the power amplifier; and
transmitting the measure of the working load to a central control unit of the mobile radio system.

14. A method according to claim 13,
wherein the power amplifier is located in a radio cell of the mobile radio system, and
wherein the central control unit is located outside the radio cell.

15. A method according to claim 14, wherein the measure of the working load of the power amplifier is dependent both on an output power currently made available by the power amplifier and on a maximum admissible output power of the power amplifier.

16. A method according to claim 15, wherein a plurality of power amplifiers are used for amplifying the signals to be transmitted to the subscriber stations, and
wherein said detecting detects at least one measure of the working load of the power amplifiers.

17. A method according to claim 16, wherein the measure of the working load of each of the power amplifiers is detected.

18. A method according to claim 17,
wherein said detecting determines the measure of the working load of the power amplifiers having a largest value, and
wherein said transmitting sends the measure with the largest value to the central control unit.

19. A method according to claim 18, further comprising
detecting a measure of the working load of a radio cell in which the power amplifiers are located, in addition to the measure of the working load of the power amplifiers, and
transmitting the measure of the working load of the radio cell to the central control unit.

20. A method according to claim 19, wherein the measure of the working load of the radio cell is dependent on both a sum of the output powers currently made available by all power amplifiers of the radio cell, and also on a maximum admissible sum of the output powers of the power amplifiers.

21. A method according to claim 20,
further comprising determining which of the measure of the working load of at least one of the power amplifiers and the measure of the working load of the radio cell has a greater value, and
wherein only one of said transmitting of the measure of the working load of the at least one of the power amplifiers to the central control unit and said transmitting of the measure of the working load of the radio cell to the central control unit is performed each time said determining determines which has the greater value.

22. A method according to claim 21, further comprising deciding on a distribution of signals to be transmitted using the power amplifiers based on the measures of the working load transmitted to the central control unit.

23. A mobile radio system having a central control unit and subscriber stations, comprising:
at least one power amplifier amplifying signals to be transmitted to the subscriber stations;
a detection unit detecting a measure for the working load of at least one the power amplifier; and
a transmission unit transmitting the measure to the central control unit of the mobile radio system.

24. A mobile radio system according to claim 23, wherein the measure of the working load of said at least one power amplifier is dependent both on an output power currently made available by said at least one power amplifier and on a maximum admissible output power of said at least one power amplifier.

25. A mobile radio system according to claim 24,
wherein said at least one power amplifier includes a plurality of power amplifiers amplifying the signals to be transmitted to the subscriber stations, and
wherein said detection unit detects at least one measure of the working load of the power amplifiers.

26. A base station for a mobile radio system having a central control unit and subscriber stations, comprising:
at least one power amplifier amplifying signals to be transmitted to the subscriber stations;
a detection unit detecting a measure for the working load of the at least one power amplifier; and
a transmission unit transmitting the measure to the central control unit of the mobile radio system.

27. A base station according to claim 26, wherein the measure of the working load of said at least one power amplifier is dependent both on an output power currently made available by said at least one power amplifier and on a maximum admissible output power of said at least one power amplifier.

28. A base station according to claim 27,
wherein said at least one power amplifier includes a plurality of power amplifiers amplifying the signals to be transmitted to the subscriber stations, and
wherein said detection unit detects at least one measure of the working load of the power amplifiers.
